(19) United States
(12) Patent Application Publication
(10) Pub. No.: US 2026/0037786 A1
(43) Pub. Date: Feb. 5, 2026

(54) KEY VALUE NEURAL NETWORK ARCHITECTURE

(71) Applicant: Writer, Inc., San Francisco, CA (US)

(72) Inventors: Umar Jamil, London (GB); Waseem AlShikh, Boca Raton, FL (US)

(73) Assignee: Writer, Inc., San Francisco, CA (US)

(21) Appl. No.: 19/271,413

(22) Filed: Jul. 16, 2025

Related U.S. Application Data
(60) Provisional application No. 63/675,867, filed on Jul. 26, 2024.

(51) Int. Cl. G06N 3/0499; G06N 3/045

(52) U.S. Cl. CPC G06N 3/0499; G06N 3/045

(57) ABSTRACT

The present disclosure relates to techniques for improving inference efficiency and memory utilization in transformer-based neural networks. A modified architectural design is introduced that decouples key and value matrix generation from inter-layer dependencies, enabling statically computed or parallelizable projections across layers. The disclosed approach may eliminate the need for layer-wise prefilling, support linear-time inference, and substantially reduce the memory footprint associated with key-value (KV) caching. The disclosed architecture may use shared or layer-specific projections, with a single KV-cache serving all or subsets of layers. In some embodiments, a non-linear transformation (e.g., implemented via a feed-forward network), may preprocess input embeddings prior to query, key, and value generation. A lookup table of transformed embeddings may be precomputed to further accelerate inference. The disclosed system can enhance scalability and may allow deployment of large models on resource-constrained hardware, offering practical benefits for latency-sensitive applications and long-context processing in transformer-based models.

### CROSS-REFERENCE TO RELATED APPLICATIONS

This application claims the priority to and the benefit of U.S. Provisional Application No. 63/675,867, filed on Jul. 26, 2024, entitled “Improved Key Value Neural Network Architecture”, which is hereby incorporated by reference in its entirety for all purposes.

### BACKGROUND

Large language models (LLMs) are artificial intelligence (AI) models trained on large-scale corpora of textual data to understand, generate, and manipulate natural language. These models are employed in a wide range of applications, including text generation, summarization, translation, programming assistance, question answering, and conversational systems across various domains such as healthcare, education, and customer service. LLMs typically process input in the form of tokens, which are derived from raw text using a tokenizer. Tokens may comprise of words, sub-words, or characters. Each token is then mapped to a dense vector representation (token embeddings)—a numerical representation in a continuous vector space—that is interpretable by neural architectures. In transformer-based architectures, including decoder-only LLMs, these token embeddings are typically of fixed dimensionality (e.g., 512, 1024, or 2048 dimensions etc.) and serve as the foundational input to subsequent layers of the model.

Transformer-based architectures may serve as the foundation for many LLMs. Within a Transformer model, the self-attention mechanism may allow each token to attend to all previous tokens using key (K) and value (V) vectors, which are typically computed by applying layer-specific projection matrices to the output of the previous layer. These K and V sequences are cached during token generation in a memory structure referred to as the key-value cache (KV-cache). Each layer of the Transformer model may maintain a separate KV-cache, which stores all intermediate K/V tokens (or K and V sequences). During token generation, each new token attends to the previously cached K/V tokens, and the resulting token is itself appended to the KV-cache for future use.

While effective, the existing design of the Transformer model may incur both computational and memory bottlenecks. Prefilling the KV-cache with the user-provided prompt incurs quadratic computational complexity with respect to prompt length. Additionally, maintaining a separate KV-cache for every layer substantially increases memory consumption, particularly for long sequences. These limitations restrict the scalability of Transformer-based LLMs for long-context processing and hinder their deployment in resource-constrained or real-time environments. Accordingly, there exists a need for improved techniques that may reduce memory and compute overhead during inference, especially in scenarios involving long input prompts.

### SUMMARY

Some embodiments of the present disclosure relate to reducing computational cost and memory requirements in neural networks by enabling layer-wise attention computation without inter-layer dependency on key or value projections. In some instances, a computer-implemented method includes accessing an input sequence comprising a plurality of ordered inputs. An output may be generated by processing the input sequence through a neural network that includes a sequence of layers arranged in a layer order starting with a first layer and followed sequentially by respective ones of a plurality of subsequent layers.

Each layer of the sequence of layers may include a self-attention sub-layer configured to generate an attention score vector based on a key matrix and a value matrix, each corresponding to the layer. The key matrix and the value matrix for each layer may be computed directly based on the input sequence and not based on any output of any layer of the sequence of layers. In some instances, the key matrix and the value matrix for each layer may be computed directly based on a modified input sequence. The modified input sequence may be generated by applying a non-linear transformation, e.g., via a lookup table. The lookup table may be precomputed using the non-linear transformation. The output may be generated based on the attention score vector computed at a final layer of the sequence of layers according to the layer order. The attention score vector may be generated using a scaled dot product.

The self-attention sub-layer may generate the attention score vector based on a query matrix corresponding to a respective layer. The query matrix may comprise a single query vector (or a one vector). The single query vector for the self-attention sub-layer of the first layer may be generated based on a last input of the input sequence according to the input order. The single query vector for each of the self-attention sub-layers in the plurality of subsequent layers may be generated based on an output of a previous layer according to the layer order.

In some embodiments, a shared key matrix and a shared value matrix may be used across all layers of the sequence. More specifically, the shared key matrix and the shared value matrix may be used as the key matrix and the value matrix for each layer of the sequence of layers of the neural network. The shared key matrix may be computed by applying a shared key weight matrix to the input sequence. Similarly, the shared value matrix may be computed by applying a shared value weight matrix to the input sequence.

In some instances, the shared key matrix may be computed by performing a first linear transformation of a modified input sequence using the shared key weight matrix. The shared value matrix may be computed by performing a second linear transformation of the modified input sequence using the shared value weight matrix. The modified input sequence may be generated by applying a non-linear transformation via a lookup table, wherein the lookup table may be precomputed using the non-linear transformation.

In some instances, the self-attention sub-layer for the first layer may compute the attention score vector based on a first query matrix comprising a single query vector generated based on a last input of the modified input sequence according to a modified input order. Further, a layer of the sequence of layers may include a feed forward network sub-layer having an activation function. The non-linear transformation may be structured based on a feed forward network sub-layer having an activation function and may utilize the activation function.

In some embodiments, instead of shared projections, each layer of the sequence of layers may have its own key and value projections. For each layer, the key matrix may be generated by applying a transformation to the input sequence using a key weight matrix specific to the layer. Similarly, the value matrix may be generated by applying the transformation using a value weight matrix specific to the layer.

In some other embodiments, the key matrix for each layer may be generated by performing a first linear transformation of a respective modified input sequence using the key weight matrix for the layer. The value matrix for each layer may be generated by performing a second linear transformation of the respective modified input sequence using the value weight matrix for the layer. The respective modified input sequence may be generated by processing the input sequence based on a respective non-linear transformation.

The self-attention sub-layer for the first layer may generate the attention score vector based on a first query matrix having one vector (or the single query vector) generated based on a last input of the respective modified input sequence according to a modified input order. The respective modified input sequence may be generated by applying a lookup table to the input sequence, wherein the lookup table may be pre-computed using the respective non-linear transformation. The respective non-linear transformation may be structured based on a feed forward network sub-layer having an activation function and may utilize the activation function.

In some instances, a computer-implemented method comprises: accessing an input sequence comprising a plurality of input tokens to be processed by a neural network model comprising a sequence of transformer layers; generating a sequence of embeddings corresponding to the input tokens using an embedding layer; for each transformer layer in the sequence of transformer layers: projecting the sequence of embeddings through a key projection matrix to generate a key sequence; projecting the sequence of embeddings through a value projection matrix to generate a value sequence; projecting a query token derived from a previous layer output through a query projection matrix to generate a query vector, where the query vector of a first layer is based on a last input of the input sequence; computing an attention output by applying an attention mechanism using the query vector, the key sequence, and the value sequence; and processing the attention output through remaining components of the transformer layer to produce a layer output; generating an output token based on a final layer output of the sequence of transformer layers; and where the key sequence and the value sequence at each layer are computed independently of outputs of any previous transformer layer, such that computation of the key sequences and the value sequences is performed with linear complexity with respect to length of the input sequence.

The key projection matrix and the value projection matrix may be shared across two or more transformer layers.

The key sequences and the value sequences for multiple transformer layers may be computed in parallel using the same sequence of embeddings.

The computer-implemented method may further include selectively storing a portion of the key sequence and the value sequence in a KV-cache; and retrieving the key sequence and the value sequence that were previously stored from the KV-cache during subsequent token generation steps.

The sequence of embeddings may be processed through a non-linear transformation function prior to projection through the key projection matrix and the value projection matrix. The non-linear transformation function may be implemented using a lookup table pre-populated with outputs of a feed-forward network.

The computer-implemented method may further include storing only input token identifiers associated with the input sequence; and re-generating on-the-fly the key sequences and the value sequences using the stored token identifiers during a resumed inference session.

In some embodiments, a system is provided that includes one or more data processors and a non-transitory computer-readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 is a block diagram of an example of a computing system which includes a neural network inference or training platform that may implement techniques in accordance with the present disclosure.

FIG. 2 is a block diagram of an example of an internal configuration of a computing device usable in a computing system according to implementations of this disclosure.

FIG. 3 is a block diagram of a neural network architecture with sequentially generated key and value matrices.

FIG. 4 shows an illustrative example of an improved neural network architecture with pre-generated key and value matrices in accordance with some embodiments of the present disclosure.

FIG. 5 shows another illustrative example of an improved neural network architecture with parallel generated key and value matrices in accordance with some embodiments of the present disclosure.

FIG. 6 illustrates an example inference by utilizing the improved neural network architecture of FIG. 4 or FIG. 5.

FIG. 7 shows an example flowchart of a system performing the inference using the improved neural network architecture in accordance with some embodiments of the present disclosure.

FIG. 8 shows another example flowchart of the system performing the inference using the improved neural network architecture in accordance with some embodiments of the present disclosure.

### DETAILED DESCRIPTION

The present disclosure discloses embodiments relating to transformer-based neural network architectures that can improve the efficiency of inference and reduce memory consumption associated with self-attention mechanisms. More specifically, the disclosed techniques may modify the architectural dependencies in transformer models to eliminate the need for layer-wise prefilling of the key and value matrices. The disclosed architectures may enable the generation of key and value matrices that are independent of the outputs of prior layers, thereby supporting linear-time inference and a reduced key/value cache footprint. According to some embodiments, a technical solution is provided in the present disclosure to a technical problem of escalating memory consumption and quadratic compute complexity during inference in self-attention-based transformer models.

Neural networks utilizing self-attention, such as the transformer, can be structured such that there is a sequence of layers that each have a self-attention sub-layer. A self-attention sub-layer may generate an attention score vector that is a vector of values that represents relationships between vectors input to the self-attention sub-layer. The self-attention sub-layer may be structured to take as input a query matrix of query vectors, a key matrix of key vectors, and a value matrix of value vectors. The self-attention score vector is generated based on these matrices. For example, a scaled dot product attention may be used to generate the self-attention score vector. The self-attention sub-layer may be configured in a multi-headed fashion to parallelize computation of the attention score vector. The self-attention sub-layer may also include a feed forward network following the self-attention sub-layer.

The layers and sub-layers in the sequence of layers may have respective weights that are used by the layers to influence the output vectors produced by the layers and sub-layers. A typical implementation of such a neural network may contain millions, billions, or trillions of such weights that are utilized when processing input through the neural network.

The weights may be determined using a training process where training data is processed through the neural network to produce an output. A loss function is used to compare the output to an expected output (according to the training data) in order to incrementally update the weights as the training data is incrementally processed by the neural network. Training may involve processing terabytes or petabytes of training data using teraFLOPS (floating point operations) or petaFLOPS of compute to do so.

To infer an output sequence from an input sequence using a neural network utilizing self-attention may require gigabytes of memory and gigaFLOPS of compute.

An implementation of a transformer model including self-attention, scaled dot product attention, and feed forward networks is described in Vaswani et al., Attention Is All You Need, 31st Conference on Neural Information Processing Systems (NIPS 2017), Long Beach, Calif., USA, (available at https://arxiv.org/pdf/1706.03762). This paper is incorporated herein by reference.

Neural networks utilizing self-attention are typically utilized in an auto-regressive fashion. For example, an input sequence is first processed by the neural network to produce an output. The neural network then repeatedly processes the input sequence plus any prior outputs to produce successive outputs. The combination of outputs is the output sequence. For sequence modeling tasks involving completion, the input sequence may be referred to as a prompt (e.g., “why did the dog cross the road?”), and the prompt may be auto-regressively processed to produce an output sequence (e.g., “to get to the other side.”).

In an example implementation of a neural network architecture, an input sequence of text may be transformed into an input sequence of identifiers. This may be done by tokenizing the text into tokens. Tokenizing may be done, for example, on a character basis, word basis, or other basis for splitting text into smaller portions to be processed by the neural network. Each token of text may be converted into an input identifier to produce an input sequence of identifiers. The input identifier is a unique value associated with a particular character, word, or other sequence of characters matching the contents of a token.

The input sequence of identifiers may be transformed into an input sequence of embeddings. An embedding is a vector of values of length d_{model} that is a semantic representation of the token. There are a variety of techniques that may be utilized to generate embeddings, such as by using word2vec, text-embedding-ada-002 provided by OpenAI, Embed provided by Cohere, or another available or trained embedding model.

The sequence of layers of the neural network may utilize matrices referred to as the query matrix, the key matrix, and the value matrix for the self-attention mechanism. In general, the query matrix may include one or more vectors for which a prediction of a next token is to be made. For the first layer in the sequence of layers, the key and value matrices may include vectors based on the input sequence of embeddings and any prior outputs. For subsequent layers in the sequence of layers, the key and value matrices may include vectors based on the embeddings from a preceding layer.

Traditionally, when an input sequence is processed by a neural network utilizing self-attention to infer an output sequence, the neural network first processes the entire input sequence in a process known as pre-filling. For the first layer of the neural network, this includes performing a linear transformation of all the embeddings corresponding to the input sequence into each of a query matrix, a key matrix, and a value matrix using respective query matrix weights, key matrix weights, and value matrix weights. For example, given an input sequence prompt of “why did the dog cross the road?” may be tokenized into [why, did, the, dog, cross, the, road,?]. Afterwards, the input sequence of embeddings may include eight vectors of length d_{model} that can be transformed into query matrix, key matrix, and value matrix, each having eight vectors. These matrices are processed through the self-attention sub-layer using scaled dot product attention to produce output vectors which may be further processed in the layer (e.g., by a feed forward sub-layer). Each layer produces an output that is passed to the next layer for further transformation and attention computation. The vectors that are output from the final layer correspond to prediction of the next token.

The purpose of pre-filling is to fill a key/value cache at each layer with values from the respective key and value matrices for each layer. The KV-cache may store previously generated key and value vectors and may update the key and value matrices during subsequent processing with cached key and value vectors. This is needed because in auto-regressive processing, the input to each subsequent step is limited, and recomputing all prior keys and values for every step is computationally prohibitive due to quadratic complexity.

A disadvantage of pre-filling and utilizing key/value caches is that the memory requirements for the KV-cache increase based on the length of the input and output sequences and the number of layers. As the number of layers in neural networks increases and the number of tokens included in the input and output sequences increases, the memory requirements for the KV-cache correspondingly increase. Another disadvantage of pre-filling is that the compute needed to pre-fill the KV-cache is quadratic with respect to the length of the input sequence because of the matrix multiplication operations between the query and key matrices which are both of a length corresponding to the input sequence length.

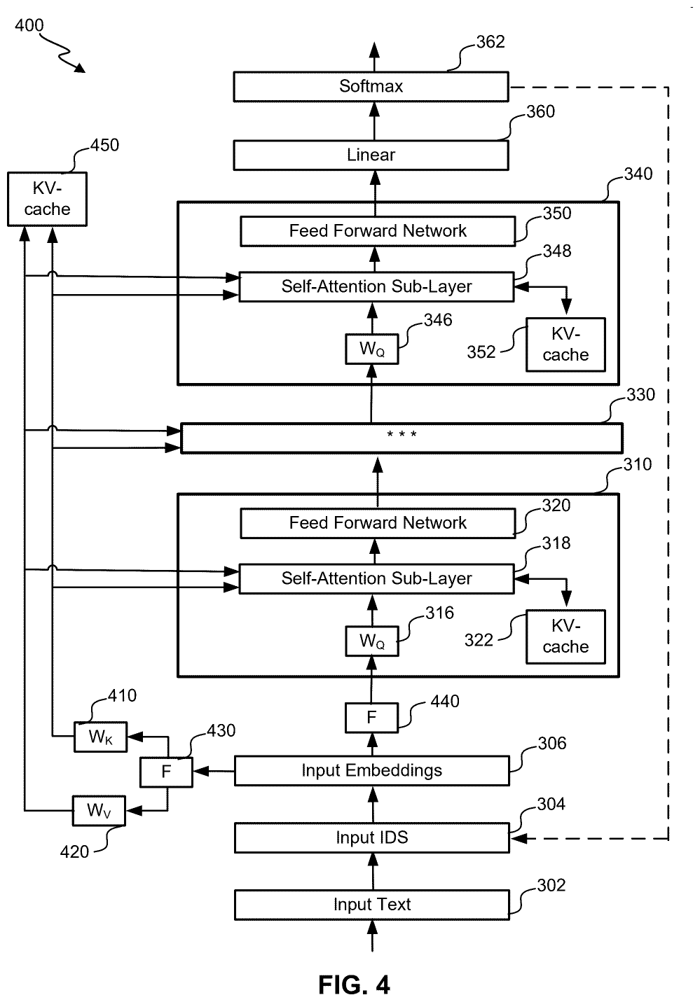

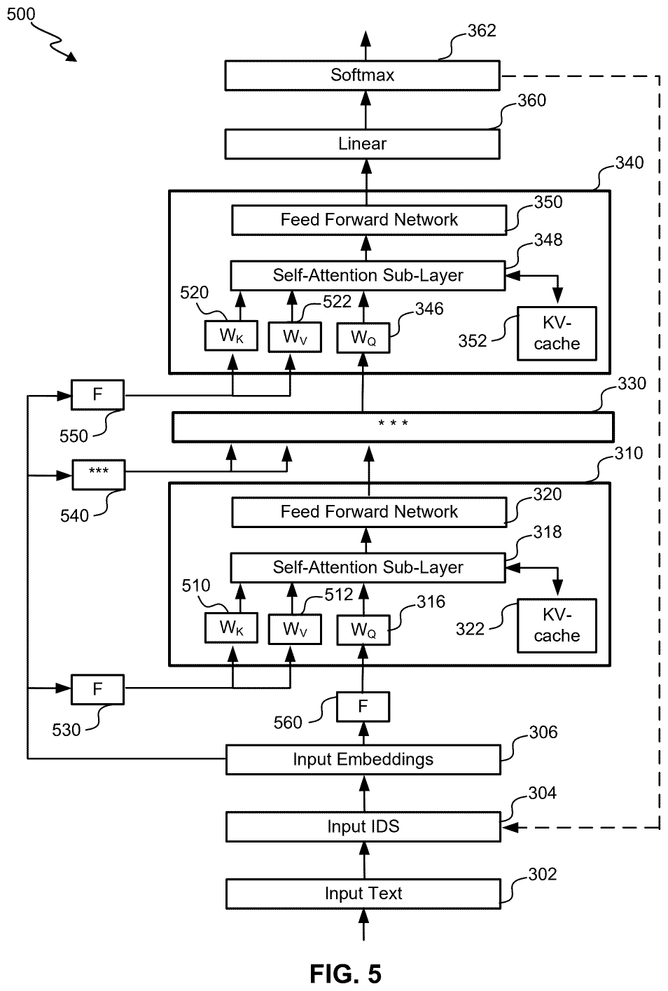

Implementations of the present disclosure may reduce disadvantages relating to pre-filling by changing the neural network architecture so that the key and value matrices for a given layer are not based on the vectors output from other layers. Instead, key and value matrices may be pre-generated for the sequence of layers or may be generated in parallel for layers of the sequence of layers based on the input sequence (as further illustrated in FIG. 4 or 5). Thus, each of the individual vectors of the key and value matrices may correspond to a single input embedding of the input sequence, instead of being a representation corresponding to the input embedding for the current position and prior positions (when the key and value matrices are based on outputs of prior layers). By removing the dependency between the output vectors of the layers and the key and value matrices, the key and value matrices may be generated with a linear computational complexity instead of a quadratic computational complexity and the memory requirements of the key/value caches can be reduced.

For example, if a common or shared key/value matrix is utilized for all the layers of the sequence of layers, a single key/value cache may be utilized instead of one for each layer. As another example, since the key and value matrices may now be computed with a linear computational complexity, some or all of the key or value vectors may not be cached given the reduced computation needed to recompute those vectors. Thus, implementations according to this disclosure are better able to tailor the compute and memory requirements of a neural network implementation based on the availability of compute and memory resources (e.g., based on the relative compute and memory provided by the particular GPU (graphical processing unit) units expected to execute the neural network implementation).

In some instances, each layer of the sequence of layers may utilize a respective key weight matrix and a respective value matrix. In some other instances, a group of layers may utilize a same or shared key weight matrix and a same or shared value weight matrix. Thus, resulting in same (shared) key and value matrices for the group of layers and a single KV-cache can be leveraged for each group to store key and value matrices. In yet some other instances, the same or shared key weight matrix and the same or shared value weight matrix may be utilized across all the layers of the sequence of layers, resulting in a single (unique) key and value matrix that can be stored in a single KV-cache. Thus, accordingly (based on the K/V weight matrices) a separate KV-cache may be used for each layer, for a group of layers, or just a single KV-cache for all the layers may be enough.

According to some aspects of the present disclosure, a non-linear transformation may also be utilized to transform embeddings to be input into the neural network (e.g., from the input sequence and prior outputs) prior to generating the key, value, and query matrices. The non-linear transformation may be performed using a feed-forward network (FFN) that can be the same or similar to a feed forward network sub-layer from the sequence of layers. For example, the structure of the FFN may be based on the structure of the feed forward network sub-layer and/or may utilize the same activation function as the feed forward network sub-layer. This FFN may be trained jointly with the neural network. In some instances, the non-linear transformation or the FFN may be layer-dependent or different for each layer of the sequence of layers. In some other instances, the non-linear normalization can be same for two or more layers, same for a group of layers, or even same for all layers.

For inference efficiency, a lookup table may be pre-computed by processing a finite vocabulary of input embeddings through the FFN. This lookup may then be used in place of live computation, enabling faster inference, particularly when a common FFN is shared across the Q, K, and V projections. For example, the lookup table may be pre-populated by processing all, or a subset of all possible input embeddings (e.g., based on the available input identifiers) through the feed forward network. Thus, when an input embedding is encountered that is pre-processed, the corresponding modified output embedding can be retrieved from the lookup table instead of having to process the input embedding through the FFN. This may be possible in cases where there is a finite set of input identifiers that are utilized (or determined to be likely to be utilized). In some implementations, the same FFN is utilized to produce modified embeddings used to generate the key, value, and query matrices, so that a single lookup table may be utilized during inference.

It may be appreciated that the techniques disclosed in the present disclosure for the transformer-based neural network architectures can effectively improve the performance of the transformer models. By enabling statically computed or parallelizable key and value matrices across transformer layers, the disclosed architecture may support linear-time inference and lower memory usage. By eliminating inter-layer dependencies for key and value generation, the transformer model may achieve linear compute complexity during inference. The reduced memory footprint may enable deployment of large models on resource-constrained devices. Moreover, the optional use of lookup tables in place of learned projection layers may further accelerate inference without substantial loss in quality. These improvements may enable broader deployment of transformer models in production environments, especially in latency-sensitive or memory-limited applications.

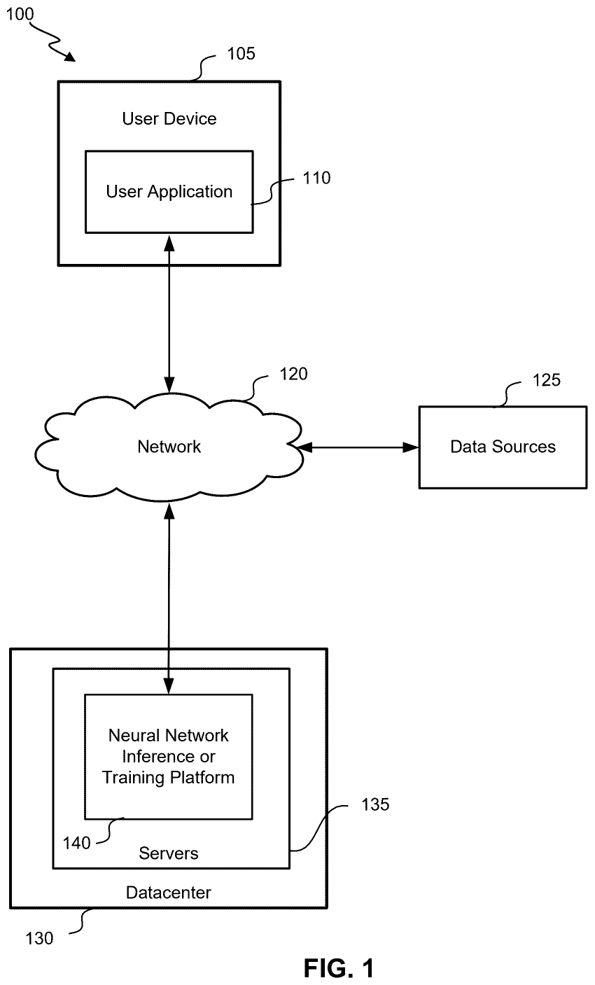

FIG. 1 is a block diagram of an example of a computing system 100 which includes a neural network inference or training platform 140 to implement the disclosed techniques. The neural network inference or training platform 140 may include software that can implement a neural network architecture and software that enables training of the neural network implementation or inference of an output sequence by processing an input sequence through the neural network implementation. A user of the neural network inference or training platform 140 such as a user of a user device 105, can use or configure a question answer platform to train a neural network implementation or perform sequence modeling tasks (e.g., inference) using the neural network implementation. Data sources 125 may be utilized to obtain training data to train the neural network implementation or to obtain input sequences to infer output sequences using the neural network implementation.

The user device 105 is a computing device capable of accessing the neural network inference or training platform 140 over the network 120, which may be or include, for example, the Internet, a local area network (LAN), a wide area network (WAN), a virtual private network (VPN), or another public or private means of electronic computer communication. For example, the user device 105 may be a mobile phone, a tablet computer, a laptop computer, a notebook computer, a desktop computer, or another suitable computing device. In some cases, the user device 105 may be registered to or otherwise associated with a customer of the neural network inference or training platform 140. The neural network inference or training platform 140 may be created and/or operated by a service provider and may have one or more customers, which may each be a public entity, private entity, or another corporate entity or individual that purchases or otherwise uses software services of the neural network inference or training platform 140. Without limitation, the neural network inference or training platform 140 can support hundreds or thousands of customers, and each of the customers may be associated with one or more user devices, such as the user device 105.

The neural network inference or training platform 140 is implemented using one or more servers 135. The servers 135 can each be a computing device or system, which can include one or more computing devices, such as a desktop computer, a server computer, or another computer capable of operating as a server, or a combination thereof. In some implementations, one or more of the servers 135 can be a software implemented server implemented on a physical device, such as a hardware server. In some implementations, a combination of two or more servers 135 can be implemented as a single hardware server or as a single software server implemented on a single hardware server.

For example, a server may run software services deliverable to user devices such as the user device 105. For example, the servers may implement web server software to provide user access to perform inference or a training task using the neural network inference or training platform 140.

In some implementations, the neural network inference or training platform 140 may be on-premises software run at a site operated by a private or public entity or individual associated with the user device 105. For example, the data sources 125 may in whole or in part be sources available at that site and then network 120 may be a LAN which connects the data sources 125 with the servers 135.

In some implementations, an instance of the neural network inference or training platform 140 can be implemented in whole or in part in a public or private cloud including servers that provide compute, memory, network, and other resources as a service. For example, an instance may be used to provide inference or training services to a single customer (e.g., single-tenant) or multiple customers (e.g., multi-tenant). In the case where a multi-tenant configuration is utilized, technological measures may be put in place to prevent data related to one customer from being used for or disclosed to another customer.

The servers 135 are located at a datacenter 130. The datacenter 130 can represent a geographic location, which can include a facility, where the one or more servers are located. The computing system 100 can include a number of datacenters and servers or can include a configuration of datacenters and servers different from that generally illustrated in FIG. 1. For example, and without limitation, the computing system 100 can include tens of datacenters, and at least some of the datacenters can include hundreds or another suitable number of servers. In some implementations, the datacenter 130 can be associated with or communicate with one or more datacenter networks or domains. In some implementations, such as where the neural network inference or training platform 140 is on-premises software, the datacenter 130 may be omitted.

The network 120, the datacenter 130, or another element, or combination of elements, of the computing system 100 can include network hardware such as routers, switches, other network devices, or combinations thereof. For example, the datacenter 130 can include a load balancer for routing traffic from the network 120 to various ones of the servers 135. The load balancer can route, or direct, computing communications traffic, such as signals or messages, to respective ones of the servers 135. For example, the load balancer can operate as a proxy, or reverse proxy, for a service, such as a service provided to user devices such as the user device 105 by the servers 135. Routing functions of the load balancer can be configured directly or via a domain name service (DNS). The load balancer can coordinate requests from user devices and can simplify access to the neural network inference or training platform 140 by masking the internal configuration of the datacenter 130 from the user devices. In some implementations, the load balancer can operate as a firewall, allowing or preventing communications based on configuration settings. In some implementations, the load balancer can be located outside of the datacenter 130, for example, when providing global routing for multiple datacenters. In some implementations, load balancers can be included both within and outside of the datacenter 130.

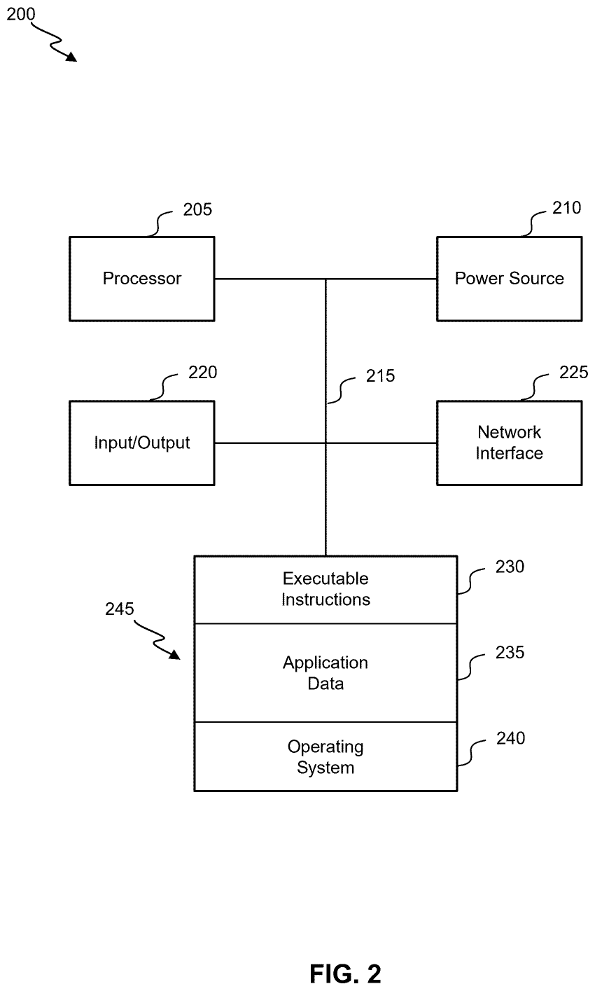

FIG. 2 is a block diagram of an example internal configuration of a computing device 200 usable with a computing system, such as the computing system 100 shown in FIG. 1. The computing device 200 may, for example, implement one or more of the user devices or one of the servers 135 of the computing system 100 shown in FIG. 1.

The computing device 200 includes components or units, such as a processor 205, a memory 245, a bus 215, a power source 210, input/output devices 220, a network interface 225, other suitable components, or a combination thereof. One or more of the memories 245, the power source 210, the input/output devices 220, or the network interface 225 can communicate with the processor 205 via the bus 215.

The processor 205 may include a central processing unit, such as a microprocessor, and can include single or multiple processors having single or multiple processing cores. The processor 205 may also include a GPU or TPU that is optimized to perform calculations needed to operate a language model. Alternatively, the processor 205 can include another type of device, or multiple devices, now existing or hereafter developed, configured for manipulating or processing information. For example, the processor 205 can include multiple processors interconnected in one or more manners, including hardwired or networked, including wirelessly networked. For example, the operations of the processor 205 can be distributed across multiple devices or units that can be coupled directly or across a local area or other suitable type of network. The processor 205 can include a cache, or cache memory, for local storage of operating data or instructions.

The memory 245 includes one or more memory components, which may each be volatile memory or non-volatile memory. For example, the volatile memory of the memory 245 can be random access memory (RAM) (e.g., a DRAM module, such as DDR SDRAM) or another form of volatile memory. In another example, the non-volatile memory of the memory 245 can be a disk drive, a solid-state drive, flash memory, phase-change memory, or another form of non-volatile memory configured for persistent electronic information storage. Generally speaking, with currently existing memory technology, volatile hardware provides for lower latency retrieval of data and is more scarce (e.g., due to higher cost and lower storage density) and non-volatile hardware provides for higher latency retrieval of data and has greater availability (e.g., due to lower cost and high storage density). The memory 245 may also include other types of devices, now existing or hereafter developed, configured for storing data or instructions for processing by the processor 205. In some implementations, the memory 245 can be distributed across multiple devices. For example, the memory 245 can include network-based memory or memory in multiple clients or servers performing the operations of those multiple devices.

The memory 245 can include data for immediate access by the processor 205. For example, the memory 245 can include executable instructions 230, application data 235, and an operating system 240. The executable instructions 230 can include one or more application programs, which can be loaded or copied, in whole or in part, from non-volatile memory to volatile memory to be executed by the processor 205. For example, the executable instructions 230 can include instructions for performing some or all of the techniques of this disclosure. The application data 235 can include user data, database data (e.g., database catalogs or dictionaries), or the like. In some implementations, the application data 235 can include functional programs, such as a web browser, a web server, a database server, another program, or a combination thereof. The operating system 240 can be, for example, Microsoft Windows®, Mac OS X®, or Linux®; an operating system for a mobile device, such as a smartphone or tablet device; or an operating system for a non-mobile device, such as a mainframe computer.

The power source 210 includes a source for providing power to the computing device 200. For example, the power source 210 can be an interface to an external power distribution system. In another example, the power source 210 can be a battery, such as where the computing device 200 is a mobile device or is otherwise configured to operate independently of an external power distribution system. In some implementations, the computing device 200 may include or otherwise use multiple power sources. In some such implementations, the power source 210 can be a backup battery.

The input/output devices 220 include one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 225 provides a connection or link to a network (e.g., the network 120 shown in FIG. 1). The network interface 225 can be a wired network interface or a wireless network interface. The computing device 200 can communicate with other devices via the network interface 225 using one or more network protocols, such as using Ethernet, transmission control protocol (TCP), internet protocol (IP), power line communication, an IEEE 802.X protocol (e.g., Wi-Fi, Bluetooth, ZigBee, etc.), infrared, visible light, general packet radio service (GPRS), global system for mobile communications (GSM), code-division multiple access (CDMA), Z-Wave, another protocol, or a combination thereof.

The foregoing description of the computing device 200 includes a number of components that may be found on a computer. However, depending on the implementation, some components may be added, deleted, or modified. For example, in some implementations, (e.g., such as with respect to the servers 135), human interface devices (e.g., input/output devices 220) may be omitted.

Disclosed techniques and systems may be implemented, for example, using the systems and devices described above with respect to FIG. 1. The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, Python, Ruby, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of traditional techniques for electronics configuration, signal processing or control, data processing, and the like. The words “mechanism” and “component” are used broadly and are not limited to hardware, mechanical or physical implementations, but can include software routines implemented in conjunction with hardware processors, etc. Likewise, the terms “system” or “tool” as used herein and in the figures, but in any event based on their context, may be understood as corresponding to a functional unit implemented using software, hardware (e.g., an integrated circuit, such as an application specific integrated circuit (ASIC)), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

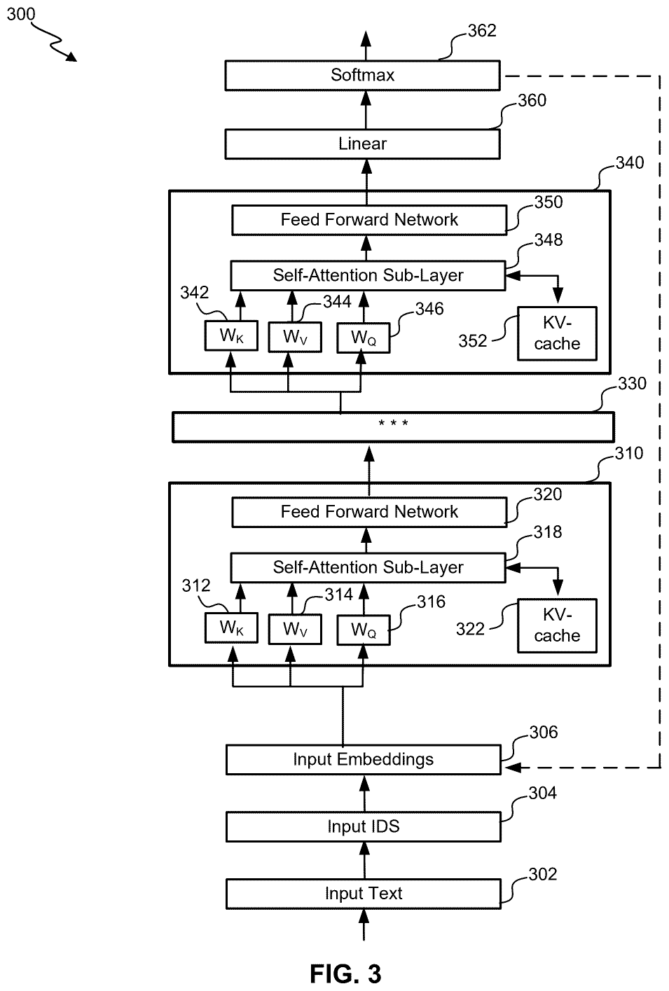

FIG. 3 is a block diagram of a neural network architecture 300 with sequentially generated key and value matrices. Neural network architecture 300 may be implemented using software, hardware, or a combination thereof, such as by using one or more computing devices 200. Neural network architecture 300 may be implemented, for example, in neural network inference or training platform 140.

At input text 302, an input sequence of text is received or provided. For example, an input sequence of text can include a series of characters in a language (e.g., such as English, French, or a computer readable language, such as Python). For example, an input sequence of text could be “why did the dog cross the road?”

At input identifiers 304 (e.g., IDs), the input sequence of text is tokenized into tokens and converted to identifiers. Tokens can be generated on various bases, such as by character, word, or sub-word. For example, on a word basis, the example input sequence of text may be tokenized into eight tokens: [why, did, the, dog, cross, the, road,?]. The tokens are assigned unique numerical identifiers. For example, the token ‘why’ may be associated with a numeral value of ‘20’. A dictionary or other process may be utilized to associate a particular sequence of characters in a token with a unique identifier. For example, the tokenized input sequence of text may be transformed into the following input sequence of eight input identifiers: [20, 48, 9328, 5813, 32, 40, 40182, 58].

At input embeddings 306, an embedding model is used to generate embedding vectors corresponding to the inputs in the input sequence of input identifiers. The embedding model may be trained specifically for an implementation of the neural network architecture or may utilize a third-party embedding model such as previously described. For example, an embedding model may produce an embedding vector for a particular identifier that has d_{model} values, such as 1024 or 4096 values. The embedding vector is a representation of information relating to that particular token. For example, after processing each input identifier of the input sequence of input identifiers through the embedding model, an input sequence of eight embeddings can be obtained: [e₁, e₂, e₃, e₄, e₅, e₆, e₇, e₈] where each e_{N} is a vector of length d_{model}. Different available embedding models may be utilized depending on the implementation, such as the embedding models previously identified.

The neural network architecture 300 includes a sequence of layers including a first layer 310 and subsequent layers including intermediate layers 330 (which may include a varying number of layers the same or similar to first layer 310, depending on the implementation), and a final layer 340. The sequence of layers sequentially process information starting with the input sequence of embeddings and for each subsequent layer, the output embeddings from the prior layer.

The first layer 310 includes three weight matrices Wₖ 312, Wᵥ 314, and W_{q} 316. These weight matrices are used to apply a linear transformation to input(s) of the input sequence of embeddings to produce respective a respective key matrix, value matrix, and query matrix for the first layer 310. The key matrix, value matrix, and query matrix are provided to self-attention sub-layer 318 which produces a matrix of attention scores (or attention score vectors). For example, self-attention sub-layer 318 may produce attention scores using scaled dot product attention. A scaled dot product may be computed, for example, as follows:

$$Attention ( Q , K , V ) = softmax ( \frac{{QK}^{T}}{\sqrt{{d}_{k}}} ) V \qquad Equation 1$$

In Equation 1, Q is the query matrix, K is the key matrix, and V is the value matrix, and dₖ is the dimension of vectors in the key matrix.

Depending on the use of the neural network architecture 300, the query matrix may be populated with a vector corresponding to the last embedding in the input sequence of embeddings, vectors corresponding to each of the embeddings in the input sequence of embeddings, or combinations thereof. In neural network architecture 300, the key and value matrices for layers 330, 340 are dependent on the outputs of prior layers, such as layer 310. However, when the query matrix does not include embeddings corresponding to each position of the input sequence (such as when the neural network processes outputs autoregressively to produce an output sequence), those outputs are not available. Including the embeddings of the entire input sequence (and prior outputs) during auto-regressive inference would be computationally complex because computational complexity increases based on the number of vectors in the query matrix.

Accordingly, KV-cache 322 is used to cache key vectors and value vectors for use in future processing using the neural network architecture 300. For example, given the eight-embedding input sequence example above, to infer an output sequence, the KV-cache 322 is first pre-filled by processing the entire input sequence through each of the key, value, and query matrices. The resulting key, value vectors in the key, value matrices are cached in the KV-cache 322. In subsequent auto-regressive processing, the key and value vectors can be retrieved from the KV-cache 322. For example, the result of prefilling includes production of an output embedding (e.g., from softmax 362) which is fed back into the neural network architecture for processing. The output embedding is used to generate a query matrix with a query vector based on the output embedding. The KV-cache 322 is used to obtain the key and value vectors previously generated relating to the embeddings not included in the query matrix for the subsequent auto-regressive process to generate attention scores using key and value vectors corresponding to the entire input sequence.

Feed forward network 320 uses the attention scores produced by self-attention sub-layer 318 to produce an output of layer 310. For example, feed forward network 320 may be implemented using the following computation:

$$FFN ( x ) = max ( 0 , {xW}_{1} + {b}_{1} ) {W}_{2} + {b}_{2} \qquad Equation 2$$

Where W₁ and W₂ are learned weight matrices and b₁ and b₂ are learned bias vectors. The example FFN in Equation 2, utilizes a ReLU (rectified linear unit) activation function in between weighted layers. The ReLU activation function can be represented as: f(x)=max(0,x).

The intermediate layers 330 may include one or more layers that are implemented the same as or similarly to the first layer 310. Each of the intermediate layers 330 may take as input the output of the prior layer (for example the first layer of the intermediate layers 330 may take as input the output of the first layer 310) and provides output to the next layer (for example, the final layer of the intermediate layers 330 may provide output to the final layer 340).

Final layer 340 can be configured and may operate the same as or similarly to the first layer 310. Final layer 340 may operate on input obtained from the output of the final layer of the intermediate layers 330. Wₖ 342, Wᵥ 344, and W_{q} 346 may operate similarly to Wₖ 312, Wᵥ 314, W_{q} 316 but have different weights (e.g., they have been trained and updated separately from the weights of the first layer), so the output of the linear transformation performed by these matrices may be different for final layer 340 as compared to the first layer 310. Self-attention sub layer 348 and feed forward network 350 are implemented the same or similarly to self-attention sub-layer 318 and feed forward network 320. Weights of the feed forward network 320 and feed forward network 350 are independently trained and thus may be different.

Linear 360 takes as input the output of the final layer 340. Linear 360 is a fully connected neural network that projects the output of the final layer 340 onto a vector of a size corresponding to an output vocabulary called a logits vector.

Softmax 362 transforms the logits into probabilities corresponding to the output vocabulary. The token in the output vocabulary having the highest probability can be selected as the output. In some implementations, instead of selecting the highest-probability token (greedy decoding), beam search may be utilized to explore multiple candidate sequences and select an output token based on a broader context of potential completions.

The output may be provided back to the neural network to enable auto-regressive generation of an output sequence. For example, if the output is in the form of an identifier or an embedding, the identifier or embedding may be appended to the input sequence of input identifiers or the input sequence of embeddings for further processing by the neural network to produce successive outputs (and ultimately an output sequence).

Traditionally, one KV-cache (e.g., KV-cache 322, 352 etc.) is included in each layer of the neural network architecture 300 (e.g., transformer model). The key and value matrices (or the K/V sequences) at every layer are the projection, respectively through the Wₖ and Wᵥ matrices, of the output of the previous layer. The K/V sequences at every layer are cached in the respective KV-cache during token generation. The KV-caches may be used during token generation, as each (generated) token “attends” to all the previous K/V tokens through the self-attention mechanism. Every new token is also saved in the K/V Cache to be used for subsequent token generation.

Moreover, when generating text with a language model (e.g. the neural network architecture 300), a user may provide the initial tokens (also known as “prompt”). These initial tokens are saved in the KV-cache of the model in order to generate new tokens in a process known as prefilling. The prefilling of the KV-cache has a quadratic computational complexity with respect to the size of the prompt. Since there is one KV-cache for each layer, the amount of memory needed for the KV-cache is substantial and can be the bottleneck in utilizing language models for long sequences.

Pseudo code describing a general structure of an implementation of a neural network consistent with neural network architecture 300 is included in the following listing:

```
func neural_network(input_ids, attention_mask, position_ids):
  # input_ids: 2d tensor of tokens generated by the tokenizer
  # attention_mask: 2d attention mask generated by the tokenizerW
  # position_ids: 2d tensor indicating which position to encode each token
as.
  hidden_states = embeddings(input_ids)
  foreach layer in layers:
    hidden_states = layer(
      hidden_states,
      attention_mask,
      position_ids
    )
  hidden_states = norm(hidden_states)
  logits = lm_head(hidden_states)
  # the user can apply the softmax for sampling or use the logits for the
Cross-Entropy-Loss
  return logits
func layer(hidden_states, attention_mask, position_ids):
  residual = hidden_states
  hidden_states = norm1(hidden_states)
  hidden_states = attention(hidden_states, attention_mask, position_ids)
  hidden_states = hidden_states + residual
  residual = hidden_states
  hidden_states = norm2(hidden_states)
  hidden_states = ffn(hidden_states)
  hidden_states = residual + hidden_states
  return hidden_states
func attention(hidden_states, attention_mask, position_ids):
  query = wq(hidden_states)
  key = wk(hidden_states)
  value = wv(hidden_states)
  # add the positional encodings to the query and the key sequences
  query, key = add_positional_encodings(query, key, position_ids)
  attn = scaled_dot_product_attention(query, key, value, attention_mask)
  output = wo(attn)
return output
```

FIG. 4 shows an illustrative example of an improved neural network architecture 400 with pre-generated key and value matrices in accordance with some embodiments of the present disclosure. Improved neural network architecture 400 may be implemented using software, hardware, or a combination thereof, such as by using one or more computing devices 200. Improved neural network architecture 400 may be implemented, for example, in neural network inference or training platform 140. Improved neural network architecture 400 includes elements common to neural network architecture 300 and reference may be had to the description of FIG. 3 with respect to such common elements.

Improved neural network architecture 400 may pre-generate key and value matrices using key weight matrix 410 and value weight matrix 420 based on the input sequence of embeddings from input embeddings 306 and may provide such key and value matrices in parallel to layers 310, 330, and 340. Unlike neural network architecture 300, improved neural network architecture 400 may generate key and value matrices without utilizing the output of any of the layers 310, 330, and 340. Thus, the generated key and value matrices are not based on and do not depend on the output of any of the layers 310, 330, and 340.

Depending on the implementation, improved neural network architecture 400 optionally includes one of or both of function 430 and function 440 to generate modified input embeddings for use in generating respective key, value, and query matrices. Functions 430, 440 may be implemented as a non-linear transformation. For example, the non-linear transformation may be implemented as a feed forward network using the same or similar structure and/or activation function as feed forward network sub layer 320. Functions 430 and 440 may utilize the same non-linear transformation or different non-linear transformations. Functions 430 and 440 may be trained such that both functions 430 and 440 utilize the same learned weights or utilize separately trained and thus different learned weights.

Functions 430 and 440 may be implemented such that they operate differently when used for inference than used in training. For example, during inference, the output of Functions 430 and 440 may be obtained using a lookup table instead of by using the non-linear transformation (e.g., which may be implemented using the FFN). The lookup table may be populated by processing an input vocabulary (or subset thereof) through the FFN for functions 430 and 440 in order to produce a lookup table including entries mapping input vocabulary identifiers or embeddings to output embeddings corresponding to what would be produced by the non-linear transformation. If functions 430, 440 are the same (with the same weights), then one lookup table may be utilized. If they are different, then multiple lookup tables corresponding to the different functions may be utilized.

Improved neural network architecture 400 may omit KV-caches 322 and 352 on a per layer basis because the key value matrices are the same for all layers. Instead, a common KV-cache 450 may be utilized to store key and value vectors for subsequent processing when an output sequence is being auto-regressively generated. Alternatively, or in addition, key and/or value vectors may be re-generated for successive processing as the neural network is used auto-regressively to generate the output sequence (and KV-cache 450 may be omitted). In some implementations, a portion of a key and value matrix may be cached, and another portion may be re-generated during successive processing by the neural network.

Improved neural network architecture 400 may reduce the memory requirement for the KV-cache and may also allow the prefilling of the KV-cache with linear time complexity with respect to the prompt length. The improved neural network architecture 400 is described using the so-called ‘decoder-only’ model, but it can also be used with any Transformer-based models, including ‘encoder-only’ and the ‘encoder-decoder model’.

Further, according to some aspects of the present disclosure, the learned projections Wₖ 410 and Wᵥ 420 can be shared for all layers, can be shared between groups of layers or can be different for each layer. For example, during token generation, in case the Wₖ 410 and Wᵥ 420 transformations are shared between all the layers then only one KV-cache is needed, as the K/V sequences would be the same for all the layers. In other cases, if layers are categorized into two groups that are sharing the Wₖ and Wᵥ projections (for example the layers 1 . . . 4 share the first Wₖ and Wᵥ, while the layers 5 . . . 8 share the second Wₖ and Wᵥ), then 2 KV-cache can be enough for the model.

FIG. 5 shows another illustrative example of an improved neural network architecture 500 with parallel generated key and value matrices in accordance with some embodiments of the present disclosure. Improved neural network architecture 500 may be implemented using software, hardware, or a combination thereof, such as by using one or more computing devices 200. Improved neural network architecture 500 may be implemented, for example, in neural network inference or training platform 140. Improved neural network architecture 500 includes elements common to neural network architecture 300 and reference may be had to the description of FIG. 3 with respect to such common elements.

Improved neural network architecture 500 may generate the key and value matrices in parallel to layers 310, 330, and 340 using weight matrices provided on a per layer basis, such as key weight matrices 510, 520 and value weight matrices 512, 522, based on the input sequence of embeddings from input embeddings 306. Resulting key and value matrices are layer specific and are used as input to their respective self-attention sub layer. Unlike neural network architecture 300, improved neural network architecture 500 generates key and value matrices without utilizing the output of any of layers 310, 330, and 340. Thus, the generated key and value matrices are not based on and do not depend on the output of any of the layers 310, 330, and 340.

Depending on the implementation, improved neural network architecture 400 optionally includes one, some or all of functions 530, 540, 550, and 560 to generate modified input embeddings for use in generating respective key, value, and query matrices. Function 540 may include multiple different functions corresponding respectively to each of layers 330. Functions 530, 540, 550, and 560 may be implemented as a non-linear transformation. For example, the non-linear transformation may be implemented as a FFN using the same or similar structure and/or activation function as feed forward network sub layer 320. Functions 530, 540, 550, and 560 may utilize the same non-linear transformation or different non-linear transformations. Functions 530, 540, 550, and 560 may be trained such that all or some of functions 530, 540, 550, and 560 utilize the same learned weights or utilize separately trained and thus different learned weights.

Functions 530, 540, 550, and 560 may be implemented such that they operate differently when used for inference than used in training. For example, during inference, the output of functions 530, 540, 550, and 560 may be obtained using a lookup table instead of by using the non-linear transformation (e.g., which may be implemented using the FFN). The lookup table may be populated by processing an input vocabulary (or subset thereof) through the FFN for functions 530, 540, 550, and 560 in order to produce a lookup table including entries mapping input vocabulary identifiers or embeddings to output embeddings corresponding to what would be produced by the non-linear transformation. If functions 530, 540, 550, and 560 are the same (with the same weights), then one lookup table may be utilized. If they are different, then multiple lookup tables corresponding to the different functions may be utilized. In some implementations, functions 530, 540, 550, and 560 may be consolidated to the extent that they utilize the same non-linear transformation.

Improved neural network architecture 500 may omit KV-caches 322 and 352 on a per layer basis if key and value vectors are not cached due to the reduction of computational complexity in generating key and value vectors. In some implementations, a portion of a key and value matrix may be cached and another portion may be re-generated during successive processing by the neural network.

Variations of improved neural network architecture 500 are possible. For example, layers of the sequence of layers may be grouped such that a key and value matrix is shared among a group of layers. With this hybrid approach the computational complexity and memory needed for key and value matrices may be reduced while still allowing for variation of the key and value weights for different groups of layers. For example, a first and second layer may be a part of a first group of layers and may utilize a single set of key and value weights to produce a single set of key and value matrices to be used by the first group of layers (e.g., the first layer and the second layer). Likewise, different combinations of functions may be utilized such that multiple layers or groups of layers utilize the same function to provide the same modified input embeddings to produce multiple key and value matrices.

Further, the disclosed techniques or architectures (e.g., in FIG. 4 and FIG. 5) are also compatible with existing training techniques and tools including Grouped Query Attention, Flash Attention, etc. The improved neural network architecture 400 or 500 may require more training time to reach the same quality of traditional approaches (e.g. transformer model or neural network architecture 300). In some instances, in the improved architectures the normalization layer may be moved before the attention and the FFN layer as compared to the original transformer model. The improved architectures may offer a compromise in which a model may be trained for longer (or a bigger model may be utilized) to reach the same quality, for the benefit of reduced memory computation and reduced compute when utilizing the model for inference.

Notably, with the improved or disclosed architectures, the K and V sequences at every layer can be materialized on-the-fly with linear time. This is not possible with the original Transformer as the K and V would be the output of the previous layer, and for the previous layer to output seqₚᵣₒₘₚₜ embeddings needs the Q to have the length of the prompt seqₚᵣₒₘₚₜ tokens, which necessarily results in a quadratic cost when computing attention (as given in Equation 1) at the previous layer.

Furthermore, with the original design of the Transformer model, Key vectors do not represent the embeddings of single tokens, but rather, contextualized embeddings that include information of multiple tokens, since the sequence of Key vectors comes from the output of the previous layer. During the attention mechanism, the output embeddings are a weighted sum of the embeddings of Value vectors, weighted according to the values of the dot products of all Query vectors with all Key vectors. According to the architectures disclosed in FIG. 4 and FIG. 5, the Key and Value vectors are always independent transformations of the embeddings of single tokens. Thus, the weights used in the attention mechanism represent how much weight is assigned to each Value vector, which is always a single token at every layer of the model. This improves the interpretability of the resulting model.

The implementations of the disclosed techniques such as the improved neural network architectures 400 or 500 can stop and resume the token generation at any moment to release the accelerator's memory for requests with higher priority. Since the cost of materializing again the Key and Value sequence grows linearly with the sequence length and the only information needed to re-materialize the Key and Value vectors is the list of input tokens (commonly known as input ids), representing the position of each token in the vocabulary, and can be stored using integers. Even when processing input sequences containing up to 1 million tokens, the total data transferred due to offloading and reloading in the accelerator's memory may amount to only 4 megabytes. The embedding layer may be consistently loaded into memory alongside the model parameters, ensuring that the embedding representations remain continuously available within the accelerator throughout inference or training.

Finally, according to improved architectures, the Key and Value sequence of vectors are a transformation of the embeddings of the tokens (and not the output of the previous layer), it is possible to compute the Key and Value sequence of multiple layers in parallel during training or inference. This cannot be done in the original Transformer model.

Pseudo code describing a general structure of an implementation of a neural network consistent with the improved neural network architecture 500 is included in the following listing:

```
func improved_neural_network(input_ids, attention_mask, position_ids):
  # input_ids: 2d tensor of tokens generated by the tokenizer
  # attention_mask: 2d attention mask generated by the tokenizer
  # position_ids: 2d tensor indicating which position to encode each token
as.
  input_embeddings = embeddings(input_ids)
  # Apply the “g” non-linear transformation. If not used, it's a no-op that
returns the input.
  hidden_states = g(input_embeddings)
  last_layers_group_index = −1
  foreach layer in layers:
    # There is no need to recompute the K and V for each layer if the
current layer shares the F, Wk and Wv transformation with the previous one.
    # In that case, we can reuse the key_hidden_states and
value_hidden_states of the previous iteration.
    # get_layer_group(...) returns a positive number unique to each group
of layers that share the F, Wk and Wv transformations.
    if get_layer_group(layer) != last_layers_group_index:
      last_layers_group_index = get_layer_group(layer)
      f, wk, wv = kv_transformation_for_layer(layer)
      key_value_hidden_states = f(input_embeddings) # F can be a no-op
like G.
      key_hidden_states = wk(key_value_hidden_states)
      key_hidden_states = add_positional_encodings(key_hidden_states,
position_ids)
      value_hidden_states = wv(key_value_hidden_states)
    hidden_states = layer(
      hidden_states,
      key_hidden_states,
      value_hidden_states,
      attention_mask,
      position_ids
    )
  hidden_states = norm(hidden_states)
  logits = lm_head(hidden_states)
  # the user can apply the softmax for sampling or use the logits for the
Cross-Entropy-Loss
  return logits
func layer(hidden_states, key_hidden_states, value_hidden_states,
attention_mask, position_ids):
  residual = hidden_states
  hidden_states = norm1(hidden_states)
  hidden_states = attention(hidden_states, key_hidden_states,
value_hidden_states, attention_mask, position_ids)
  hidden_states = hidden_states + residual
  residual = hidden_states
  hidden_states = norm2(hidden_states)
  hidden_states = ffn(hidden_states)
  hidden_states = residual + hidden_states
  return hidden_states
func attention(hidden_states, key_hidden_states, value_hidden_states,
attention_mask, position_ids):
  query = wq(hidden_states)
  key = key_hidden_states
  value = value_hidden_states
  # add the positional encodings to the query
  query = add_positional_encodings(query, position_ids)
  attn = scaled_dot_product_attention(query, key, value, attention_mask)
  output = wo(attn)
return output
```

In the foregoing pseudocode. g( ) may correspond to function 560 and f( ) may correspond to one or more of functions 530, 540, and 550.

Variations of neural network architecture 300 and improved neural network architectures 400 and 500 are possible and expected. For example, layers may be structured differently and include additional, fewer, modified, or different components. For example, additional sub-layers or variations of sub-layers described are possible. Additional or fewer pre-processing or post-processing components may be utilized (e.g., in addition to, modifying, or replacing components 302, 304, 306, 360, and 362).

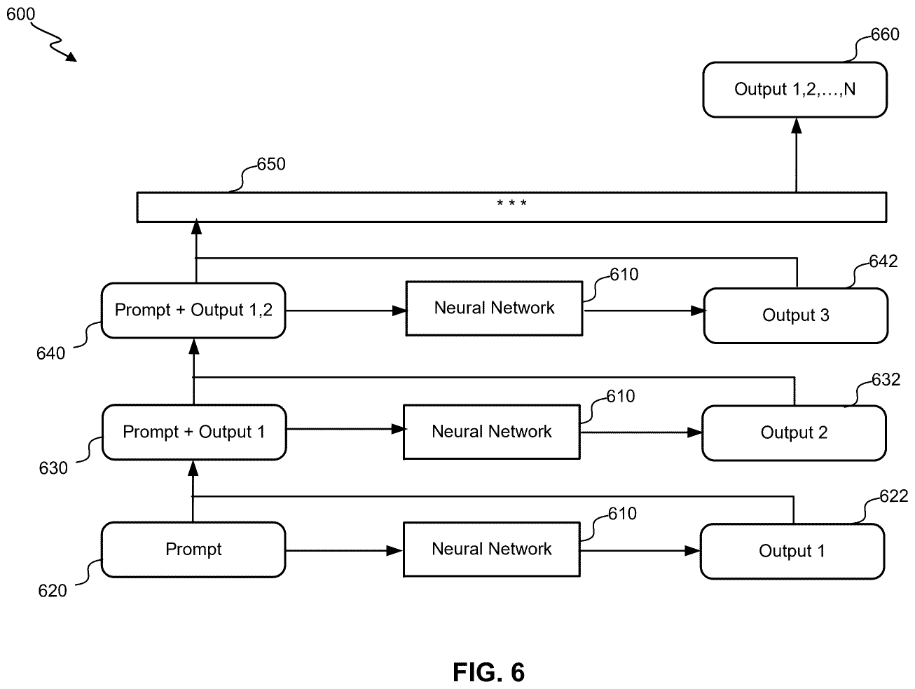

FIG. 6 shows an example illustration 600 of inference by utilizing the improved neural network architectures 400, 500. Neural network 610 may be, for example, an implementation of an improved neural network architecture such as described above with respect to FIG. 4 and/or FIG. 5. The process of example illustration 600 may be implemented in computing device(s) and/or systems such as those previously described with respect to FIG. 1 and FIG. 2.

Example illustration 600 demonstrates how a neural network implementation may be utilized auto-regressively to generate an output sequence one output at a time. For example, a prompt 620 may be provided to the neural network 610 to produce a first output 622. The first output 622 is appended to the prompt 620 at prompt+first output 630 which is provided to neural network 610 to produce a second output 632. The second output 632 is appended to the prompt+first output at prompt+first and second output 640 which is provided to neural network 610 to produce a third output 642. The third output 642 may be provided to successive iterations 650 of processing using neural network 610 until such time that an output sequence 660 is generated.

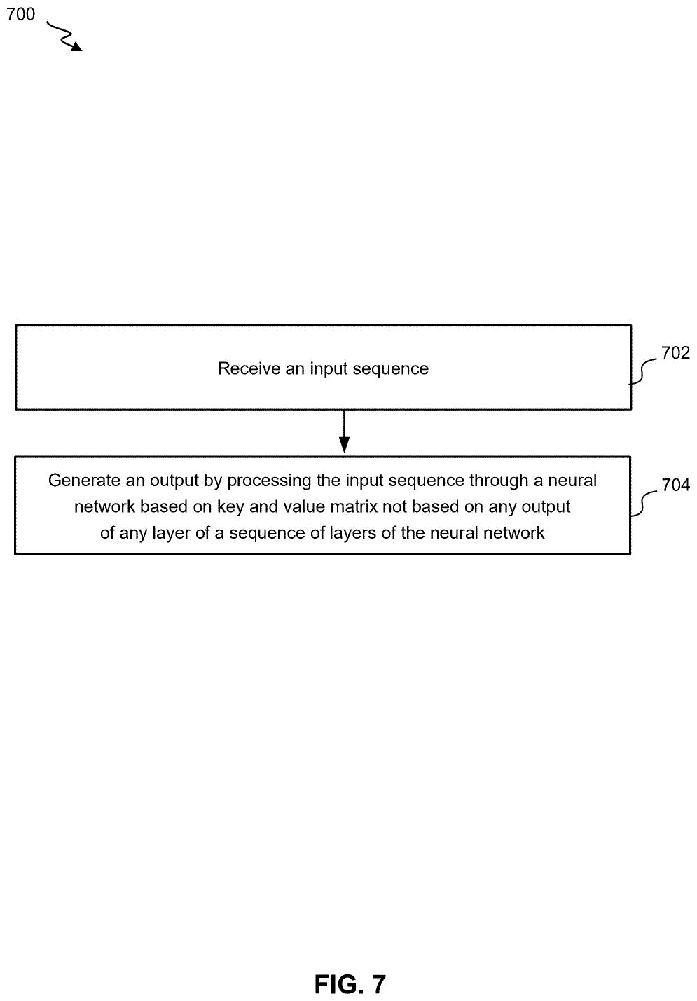

FIG. 7 shows an example flowchart 700 of a system performing the inference using the improved neural network architecture in accordance with some embodiments of the present disclosure. The blocks in the example flowchart 700 may be performed in a system, such as neural network inference or training platform 140 using one or more computing devices such as computing device 200. For example, blocks or processes in the example flowchart 700 may be performed using an implementation of an improved neural network architecture such as depicted and described with respect to FIG. 4 and/or FIG. 5.

The blocks in flowchart are illustrated in a specific order, while the order can be modified, for example, some blocks may be performed before others, and some blocks may be performed simultaneously. The blocks can be performed by hardware or software or a combination thereof. The process at block 702 may include receiving an input sequence having a plurality of ordered inputs. For example, the input sequence may be an input sequence of text, input identifiers, or embeddings, such as described previously with respect to input text 302, input identifiers 304, and input embeddings 306.

Further, an output may be generated by processing the input sequence (or a transformation thereof) through a neural network based on a key matrix and a value matrix not based on any output of any layer of a sequence of layers of the neural network, at block 704. The sequence of layers has several layers in a layer order starting with a first layer and followed sequentially by respective ones of a plurality of subsequent layers. Each layer includes a self-attention sub-layer that generates an attention score vector based on a respective key matrix and a respective value matrix for that layer. The respective key matrix and respective value matrix are generated based on the input sequence.

In some implementations, the input sequence may be processed based on a respective query matrix for each self-attention sub-layer that has one vector (or a single query vector). The one vector of the query matrix for a first layer of the layer sequence is generated based on a last input of the input sequence according to an input order of the input sequence. For subsequent layers, the one vector of respective query matrices is obtained from an output of a pervious layer of the sequence of layers according to the layer order.

In some implementations, the attention score vector is generated using a scaled dot product.

In some implementations, a common or shared key matrix generated based on a common or shared key weight matrix and the input sequence is used as the respective key matrix for each layer of the sequence of layers. In such an implementation a common or shared value matrix generated based on a common or shared weight matrix and the input sequence is used as the respective value matrix for each of the plurality of layers. For example, such implementations may be implemented as described with respect to FIG. 4 such as described with respect to key weight matrix 410 and value weight matrix 420.

In some implementations, the shared key matrix is generated by performing a first linear transformation of a modified input sequence using the shared key weight matrix, the shared value matrix is generated by performing a second linear transformation of the modified input sequence using the shared value weight matrix, and the modified input sequence is generated by processing the input sequence based on a non-linear transformation. In such an implementation, the self-attention sub-layer for the first layer may generate the attention score vector based on a first query matrix having one vector generated based on a last input of the modified input sequence according to a modified input order of the modified input sequence. In such an implementation, the modified input sequence may be generated by processing the input sequence based on the non-linear transformation by applying a lookup table to the input sequence, wherein the lookup table is pre-computed using the non-linear transformation. In such an implementation, the sequence of layers includes a feed forward network sub-layer having an activation function and the non-linear transformation may be structured based on the feed forward network sub-layer and utilizes the activation function. For example, such implementations may be implemented as described with respect to FIG. 4 such as described with respect to functions 430, 440 and key weight matrix 410 and value weight matrix 420.

In some implementations, for each respective layer of the sequence of layers, the key matrix for the respective layer is generated based on a key weight matrix for the respective layer and the input sequence. Similarly, for each respective layer of the sequence of layers, the value matrix for the respective layer is generated based on a value weight matrix for the respective layer and the input sequence. For example, such implementations may be implemented as described with respect to FIG. 5 such as described with respect to key weight matrices 510, 520 and value weight matrices 512, 522.

In some implementations, for each respective layer of the sequence of layers, the key matrix for the respective layer is generated by performing a first linear transformation of a respective modified input sequence using the key weight matrix for the respective layer. Similarly, for each respective layer of the sequence of layers, the value matrix for the respective layer is generated by performing a second linear transformation of the respective modified input sequence using the value weight matrix for the respective layer. The respective modified input sequence is generated by processing the input sequence based on a respective non-linear transformation. In such implementations, the self-attention sub-layer for the first layer may generate the attention score vector based on a first query matrix having one vector generated based on a last input of the respective modified input sequence according to a modified input order of the respective modified input sequence. In such implementations, the respective modified input sequence may be generated by processing the input sequence based on the respective non-linear transformation by applying a lookup table to the input sequence and the lookup table may be pre-computed using the respective non-linear transformation. In such implementations, the self-attention sub-layer for the first layer may generate the attention score vector based on a first query matrix having one vector generated based on a last input of the respective modified input sequence according to a modified input order of the respective modified input sequence. In such an implementation, a layer of the sequence of layers may include a feed forward network sub-layer having an activation function, and the respective non-linear transformation may be structured based on the feed forward network sub-layer and utilize the activation function. For example, such implementations may be implemented as described with respect to FIG. 5 such as described with respect to key weights 510, 520, value weights 512, 522, and functions 530, 540, 550, and 560.

Implementations of block 704 may include additional variations or modifications consistent with implementations of improved neural network architectures previously described with respect to FIG. 4 and FIG. 5. For example, an output sequence may be generated by combining outputs generated by the neural network. For example, the output sequence may be stored or may be included in a user interface to be displayed on a computing device.

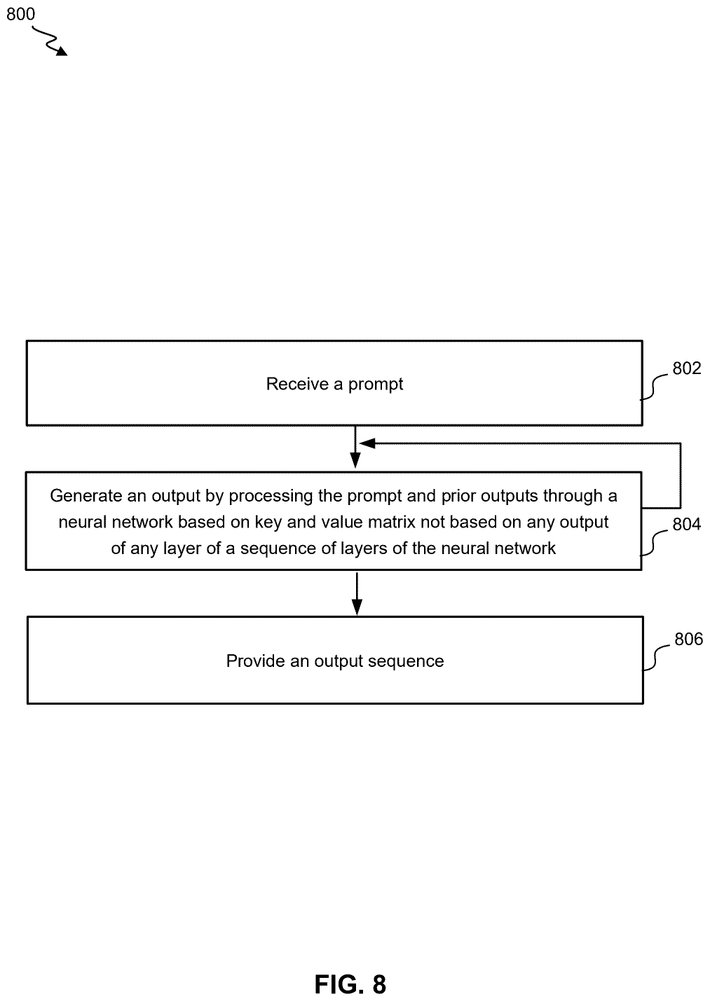

FIG. 8 shows another example flowchart 800 of the system performing the inference using the improved neural network architecture in accordance with some embodiments of the present disclosure. The blocks in the example flowchart 800 may be performed in a system, such as neural network inference or training platform 140 using one or more computing devices such as computing device 200. For example, blocks or processes in the example flowchart 800 may be performed using an implementation of an improved neural network architecture such as depicted and described with respect to FIG. 4 and/or FIG. 5. For example, blocks or processes in the example flowchart 800 may be performed in specific use cases consistent with the description of FIG. 6.

The blocks in flowchart are illustrated in a specific order, while the order can be modified, for example, some blocks may be performed before others, and some blocks may be performed simultaneously. The blocks can be performed by hardware or software or a combination thereof. The process at block 802 may include receiving a prompt. For example, a prompt may include an input sequence of text responsive to which an output sequence of text is expected to be produced. For example, the prompt may correspond to an input sequence of text, such as described previously with respect to input text 302.

Further, an output may be generated by processing the input sequence (or a transformation thereof) through a neural network based on a key matrix and a value matrix not based on any output of any layer of a sequence of layers of the neural network, at block 804. The sequence of layers has several layers in a layer order starting with a first layer and followed sequentially by respective ones of a plurality of subsequent layers. Each layer includes a self-attention sub-layer that generates an attention score vector based on a respective key matrix and a respective value matrix for that layer. The respective key matrix and respective value matrix are generated based on the input sequence. Further variations of implementations of block 804 are possible, such as variations described with respect to block 704 in the example flowchart 700. The process at block 804 may be repeated to produce successive outputs until a determination is made that all outputs have been generated.

Finally, at block 806, an output sequence is provided by combining the outputs generated by the repeated execution of process at block 804. For example, the output sequence may be stored or may be included in a user interface to be displayed on the computing device 200.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, Python, Ruby, assembler, or the like, with the various algorithms being implemented with a combination of data structures, objects, processes, routines, or other programming elements. Functional aspects can be implemented in algorithms that execute on one or more processors. Furthermore, the implementations of the systems and techniques disclosed herein could employ a number of traditional techniques for electronics configuration, signal processing or control, data processing, and the like. The words “mechanism” and “component” are used broadly and are not limited to hardware, mechanical or physical implementations, but can include software routines implemented in conjunction with hardware processors, etc. Likewise, the terms “system” or “tool” as used herein and in the figures, but in any event based on their context, may be understood as corresponding to a functional unit implemented using software, hardware (e.g., an integrated circuit, such as an application specific integrated circuit (ASIC)), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

While the disclosure has been described in connection with specific implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

Some embodiments of the present disclosure include a system including one or more data processors. In some embodiments, the system includes a non-transitory computer-readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability, or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
accessing an input sequence comprising a plurality of input tokens to be processed by a neural network model comprising a sequence of transformer layers;
generating a sequence of embeddings corresponding to the input tokens using an embedding layer;
for each transformer layer in the sequence of transformer layers:
projecting the sequence of embeddings through a key projection matrix to generate a key sequence;
projecting the sequence of embeddings through a value projection matrix to generate a value sequence;
projecting a query token derived from a previous layer output through a query projection matrix to generate a query vector, wherein the query vector of a first layer is based on a last input of the input sequence;
computing an attention output by applying an attention mechanism using the query vector, the key sequence, and the value sequence; and
processing the attention output through remaining components of the transformer layer to produce a layer output;
generating an output token based on a final layer output of the sequence of transformer layers; and
wherein the key sequence and the value sequence at each layer are computed independently of outputs of any previous transformer layer, such that computation of the key sequences and the value sequences is performed with linear complexity with respect to length of the input sequence.

2. The computer-implemented method of claim 1, wherein the key projection matrix and the value projection matrix are shared across two or more transformer layers.

3. The computer-implemented method of claim 1, wherein the key sequences and the value sequences for multiple transformer layers are computed in parallel using the same sequence of embeddings.

4. The computer-implemented method of claim 1, further comprising:
selectively storing a portion of the key sequence and the value sequence in a KV-cache; and
retrieving the key sequence and the value sequence that were previously stored from the KV-cache during subsequent token generation steps.

5. The computer-implemented method of claim 1, wherein the sequence of embeddings is processed through a non-linear transformation function prior to projection through the key projection matrix and the value projection matrix.

6. The computer-implemented method of claim 5, wherein the non-linear transformation function is implemented using a lookup table pre-populated with outputs of a feed-forward network.

7. The computer-implemented method of claim 1, further comprising:
storing only input token identifiers associated with the input sequence; and
re-generating on-the-fly the key sequences and the value sequences using the stored token identifiers during a resumed inference session.

8. A system comprising:
one or more data processors; and
a non-transitory computer-readable storage medium containing instructions which, when executed on the one or more data processors, cause the one or more data processors to perform a set of operations including:
accessing an input sequence comprising a plurality of input tokens to be processed by a neural network model comprising a sequence of transformer layers;
generating a sequence of embeddings corresponding to the input tokens using an embedding layer;
for each transformer layer in the sequence of transformer layers:
projecting the sequence of embeddings through a key projection matrix to generate a key sequence;
projecting the sequence of embeddings through a value projection matrix to generate a value sequence;
projecting a query token derived from a previous layer output through a query projection matrix to generate a query vector;
computing an attention output by applying an attention mechanism using the query vector, the key sequence, and the value sequence; and
processing the attention output through remaining components of the transformer layer to produce a layer output;
generating an output token based on a final layer output of the sequence of transformer layers; and
wherein the key sequence and the value sequence at each layer are computed independently of outputs of any previous transformer layer, such that computation of the key sequences and the value sequences is performed with linear complexity with respect to length of the input sequence.

9. The system of claim 8, wherein the key projection matrix and the value projection matrix are shared across two or more transformer layers.

10. The system of claim 8, wherein the key sequences and the value sequences for multiple transformer layers are computed in parallel using the same sequence of embeddings.

11. The system of claim 8, further comprising:
selectively storing a portion of the key sequence and the value sequence in a KV-cache; and
retrieving the key sequence and the value sequence that were previously stored from the KV-cache during subsequent token generation steps.

12. The system of claim 8, wherein the sequence of embeddings is processed through a non-linear transformation function prior to projection through the key projection matrix and the value projection matrix.

13. The system of claim 8, wherein the non-linear transformation function is implemented using a lookup table pre-populated with outputs of a feed-forward network.

14. The system of claim 8, further comprising:
storing only input token identifiers associated with the input sequence; and
re-generating on-the-fly the key sequences and the value sequences using the stored token identifiers during a resumed inference session.

15. A computer-program product tangibly embodied in a non-transitory machine-readable storage medium, including instructions configured to cause one or more data processors to perform a set of operations comprising:
accessing an input sequence comprising a plurality of input tokens to be processed by a neural network model comprising a sequence of transformer layers;
generating a sequence of embeddings corresponding to the input tokens using an embedding layer;
for each transformer layer in the sequence of transformer layers:
projecting the sequence of embeddings through a key projection matrix to generate a key sequence;
projecting the sequence of embeddings through a value projection matrix to generate a value sequence;
projecting a query token derived from a previous layer output through a query projection matrix to generate a query vector;
computing an attention output by applying an attention mechanism using the query vector, the key sequence, and the value sequence; and
processing the attention output through remaining components of the transformer layer to produce a layer output;
generating an output token based on a final layer output of the sequence of transformer layers; and
wherein the key sequence and the value sequence at each layer are computed independently of outputs of any previous transformer layer, such that computation of the key sequences and the value sequences is performed with linear complexity with respect to length of the input sequence.

16. The computer-program product of claim 15, wherein the key projection matrix and the value projection matrix are shared across two or more transformer layers.

17. The computer-program product of claim 15, wherein the key sequences and the value sequences for multiple transformer layers are computed in parallel using the same sequence of embeddings.

18. The computer-program product of claim 15, further comprising:
selectively storing a portion of the key sequence and the value sequence in a KV-cache; and
retrieving the key sequence and the value sequence that were previously stored from the KV-cache during subsequent token generation steps.

19. The computer-program product of claim 15, wherein the sequence of embeddings is processed through a non-linear transformation function prior to projection through the key projection matrix and the value projection matrix.

20. The computer-program product of claim 15, further comprising:
storing only input token identifiers associated with the input sequence; and
re-generating on-the-fly the key sequences and the value sequences using the stored token identifiers during a resumed inference session.
